(19) United States
(12) Patent Application Publication
(10) Pub. No.: US 2012/0088519 A1
(43) Pub. Date: Apr. 12, 2012

(54) MOBILE DEVICE FOR LOW POWER IDENTIFICATION OF ITS POSITION AND A METHOD THEREFORE

(75) Inventors: Kare Agardh, Rydeback (SE); Magnus Persson, Flyinge (SE)

(73) Assignee: SONY ERICSSON MOBILE COMMUNICATIONS AB, Lund (SE)

(21) Appl. No.: 13/203,864

(22) PCT Filed: Oct. 6, 2010
(86) PCT No.: PCT/EP10/64937

§ 371 Date: Aug. 30, 2011

(51) Int. Cl. H04W 52/02; H04W 64/00

(52) U.S. Cl. 455/456.1

(57) ABSTRACT

The present invention relates to a method in a mobile device and a mobile device for low power identification of its position in an indoor environment, in which beacon transmitters of a beacon system are present. The device receives a notification from at least one of the beacon transmitters of the beacon system that notifies the mobile device that it is within the range of the beacon system. Thus it is the beacon transmitters that perform the continuous scanning to identify if the mobile device is within range and not the mobile device itself. This will reduce the power consumption of the mobile device substantially. The mobile device will than request that the beacon transmitters within range to send data pertaining to their position, and then determine its position by performing calculations based on such data.

### TECHNICAL FIELD OF THE INVENTION

The present invention relates to a mobile device for low power identification of its geographic position and a method therefore. The present invention is especially useful when the mobile device is in an indoor environment.

### DESCRIPTION OF RELATED ART

A common feature in today's modern mobile devices is that they are able to determine their geographic position. For outdoor use there are several technologies that may be used in order to determine the position of a wireless communication device such as the mobile device. The use of Global Positioning System (GPS) is one technology that may be used to identify the position of a mobile device all over the world. However, the use of GPS in a mobile device increases the power consumption of the mobile device which is a significant drawback. To overcome this problem Assisted GPS (A-GPS) may be used. A-GPS uses the fact that the mobile device is already connected to land-based network stations in order to incorporate better and more efficient positioning determination in the mobile devices.

However, during time periods when the mobile device is in an indoor environment none of the above technologies is very useful, since a roof often blocks the signals from the satellites. To this end it will be more and more common to place beacon systems in public buildings, such as airports, shopping malls etc. Such beacon system for indoor positioning of mobile devices may be based on a wireless communication system such as Wi-Fi, Bluetooth or ultra-wideband. The same basic problem as for GPS also applies to this indoor solution, i.e. the search of beacons in the indoor environment will increase the power consumption of the mobile device.

This problem has at least two different dimensions. Firstly the mobile device requires more power during the scanning for beacon transmitters, which is a known tradeoff in order to be able to get the position of the mobile device. Secondly it is not sure that an indoor wireless system is present or available, leading to constant power consuming while searching for beacon transmitters even if they are not present. Since most public buildings today are without beacon systems for positioning the mobile device will constantly search for beacons that may be used for positioning, which leads to high power consumption and a low success rate.

Most mobile devices will probably not be at a location where positioning with indoor beacon systems is available more than for instance 5% of their lifetime. This will make it hard to motivate that mobile devices continuously should search for positioning beacons, i.e. the tradeoff between knowing the position of the mobile device and the power consumption is poor.

Thus there is a need for a method and a device with which the indoor positioning problem can be solved without excessive power consumption.

### SUMMARY OF THE INVENTION

Hence, it is an object of the present invention to overcome the above-identified deficiencies related to the prior art and create a mobile device and a method therefore that is able to substantially reduce the power consumption while determining its position.

According to a first aspect of the present invention this object is fulfilled by a method in a mobile device for low power identification of its position in an indoor environment, in which beacon transmitters of a beacon system are present. The method comprises the steps of receiving a notification from at least one of the beacon transmitters of the beacon system that notifies the mobile device that it is within the range of the beacon system. The mobile device then requests that the beacon transmitters that are within the range of the mobile device send data pertaining to their position. This data is then used to calculate the position of the mobile device.

In a preferred embodiment of the invention the step of receiving the notification further includes the step of receiving the notification from the beacon transmitter via a positioning server.

In yet another embodiment the method according to the present invention bases the calculation on range measurements performed by the mobile device.

In another embodiment of the present invention the method bases the calculation on range measurements performed by the beacon transmitters.

In yet another embodiment of the method all communication between the mobile device and the beacon transmitters is performed via the positioning server.

According to a second aspect of the present invention this object is fulfilled by a mobile device for low power identification of its position in an indoor environment, in which beacon transmitters of a beacon system are present, said mobile device being configured to execute the steps of receiving a notification from at least one of the beacon transmitters of the beacon system that notifies the mobile device that it is within the range of the beacon system, requesting that the beacon transmitters that are within the range of the mobile device send data pertaining to their position, and determining its position by performing calculations based on such data.

According to one embodiment the mobile device is further configured to receiving the notification from the beacon transmitters via a positioning server.

In yet another embodiment the mobile device is configured to perform range measurements on which the calculations are based.

In another embodiment the mobile device is configured to receive range measurements on which the calculations are based from the beacon transmitters.

In yet another embodiment the mobile device is configured to communicate with all the beacon transmitters via the positioning server.

Thus according to the present invention there is a power efficient method for determining the indoor position of a mobile device. There are many situations in which such information about the position is useful. This information may be useful to determine when and where an airport terminal is crowed or at which positions in shopping malls advertisements are best placed.

### BRIEF DESCRIPTION OF THE DRAWINGS

The present invention will now be described in more detail in relation to the enclosed drawings, in which:

FIG. 1 schematically shows a mobile device according to the present invention,

FIG. 2 illustrates an indoor environment, in which beacons are used to determine the position of a mobile device,

FIG. 3 is a flow chart showing the steps of the method according to the present invention.

### DETAILED DESCRIPTION OF EMBODIMENTS

In the description of the present invention it will be referred to beacon systems or wireless communication systems which may be used interchangeable and may be systems such as Wi-Fi or a wireless local area network (WLAN), Bluetooth, an ultra-wideband (UWB) or the like. Thus, in context of the present invention the type of wireless communication system used is not of importance, but instead that there is such a system present and that the mobile device is capable of connecting to and exchanging information through such a wireless communication system.

A mobile device according to the present invention will now be described in relation to a cellular telephone, which is a preferred variation of the invention. However, the portable communication device can also be another type of device, like a cordless telephone, a communication module, a PDA or a lap top computer or any other type of portable device communicating with radio waves.

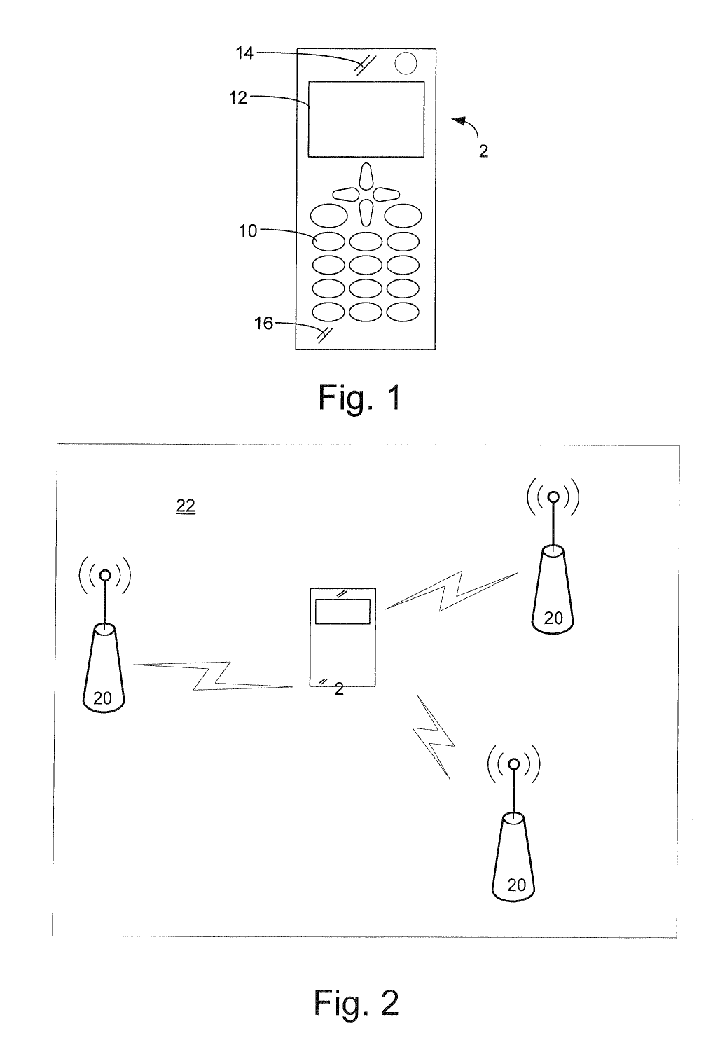

FIG. 1 schematically shows a front view of a cellular telephone 2 according to an embodiment of the present invention. The telephone 2 includes input/output devices such a number of keys 10 on a keypad provided below a display 12, a loud speaker 14 and a microphone 16. These are all common features for a portable communication device and are well known by a person skilled in the art and are therefore not described in detail. It might be such a cellular telephone that is provided with capabilities to communicate with an indoor beacon system.

In FIG. 2 reference numeral 22 depicts an indoor environment in which the position of the mobile device 2 is to be determined. Even though only one mobile device 2 is shown in FIG. 2 it should be understood that a typical indoor environment contains a large number of mobile devices, but these are not shown in FIG. 2 due to clarity. Such an indoor environment may be an airport, a shopping mall, large department stores etc. According to the present invention such an indoor environment is provided with a beacon system, with which help the position of the mobile device may be determined. In the indoor environment of FIG. 2 three beacon transmitters 20 are shown. However, it should be understood that the number of beacon transmitters will vary depending on the size and layout of the building and also of course depending on the type of wireless communication system used. The beacon system may as an option also be connected to a positioning server 24, which is to be described further below.

The general inventive concept of the present invention is to let the beacon transmitters 20 of the wireless communication system do the power consuming continues scanning instead of the mobile device 2, i.e. the beacon transmitters 20 are searching for mobile devices 2 instead of the other way around. This will greatly reduce the power consumption of the mobile device 2 and since the beacon transmitters 20 usually are connected to a power source it will not negatively affect the performance of the beacon transmitters 20.

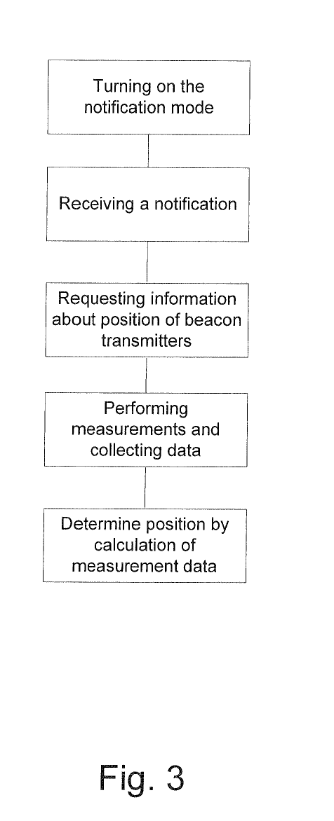

To better understand the present invention a method in the mobile device 2 for low power identification of its position will be described in relation to FIG. 3. It should be understood that in order for the method to work the mobile device 2 of the present invention is configured to communicate with the position determining wireless communication system, such as Bluetooth system, Wi-Fi system, Internet or the like.

Thus according to one embodiment of the present invention the mobile device 2 is set up and configured to be able to receive a notification from the position determining wireless communication system, i.e. it is in a notification mode. Notification can be done in at least two different ways. Firstly, one of the beacon transmitters 20 of the wireless communication system may notify the mobile device 2 that it is within such a range that its position may be determined. Secondly, as mentioned above the beacon transmitters 20 may be connected to the positioning server 24, which in turn notifies the mobile device 2 when it is within range. The great benefit with using the positioning server 24 is that the mobile device 2 only needs to communicate with one entity, i.e. one access point instead of several different access points, i.e. the beacon transmitters 20 within range. Furthermore, there is no need for configuring the mobile device 2 for different wireless communication systems since it only needs to communicate with the positioning server 24, for example through Internet. As is shown in FIG. 2 the positioning server 24 is connected to the beacon transmitters 20 and is capable of collecting data about range measurements performed by the beacon transmitters.

After receiving this notification that the mobile device 2 is within range positioning measurements may be performed.

As mentioned above, this requires that the mobile device 2 is configured to communicate with the beacon transmitters 20 or the positioning server 24 and that this option is turned on. It is recognized that having this notification mode turned on may consume some additional power in relation to a normal operational mode. However this power consumption is almost negligible in comparison with the continuous scanning for beacon transmitters 20 that the mobile devices 2 with today's technology perform.

In a preferred embodiment the user of the mobile device 2 may initiate this notification step turning by switching to the notification mode. In this way the user has the possibility to make even greater power savings for example when power is scarce.

Positioning measurements may be done in a number of different ways depending on the wireless communication system. In the simplest case, i.e. when the range of each individual beacon transmitter 20 is a few meters the position of the closet beacon transmitter 20 may sent to the mobile device 2 as the position thereof, either directly from that beacon transmitter 20 or through the positioning server 24. Thus, in concept of the present invention the meaning of position measurement is to be interpreted broadly and also include the above mention case where the known position of the closest beacon transmitter 20 is transferred from the beacon transmitter 20 to the mobile device 2.

With another wireless communication system the mobile device 2 will request that the beacon transmitters 20 that are within range send data pertaining to their position, i.e. the mobile device 2 will receive data from several beacon transmitters 20. Also this data may be sent via the positioning server 24 instead of directly via the beacon transmitters 20. This information will be used in determining the position of the mobile device 2 by letting it calculate the position based on the measurement data collected. There are a lot of different ways to calculate the position based on the collected measurement data, for example to perform triangulation, use fingerprinting etc. As is known to a person skilled in the art triangulation may be performed by using received signal strength indicator (RSSI), time of arrival calculations or the like. It is within the capacity of a skilled person to choose the technology used to perform position calculations.

The position calculation may be based on range measurements, or other measurements, which may be performed by the mobile device 2 or by the beacon transmitters 20. By letting the beacon transmitters 20 perform the range measurements power consumption may be reduced further.

To summarize the above method three examples of how the mobile device 2 may be configured will be described. In the first example the mobile device 2 is configured to be able to receive notifications from an indoor wireless communication network. Thus, as soon as the mobile device 2 is within range of the beacon transmitters 20 of the wireless communication network the mobile device 2 will get notified, since the beacon transmitters 20 perform continuous scanning to identify when a mobile device 2 is within range. When the mobile device 2 has received the notification it will begin to scan for beacon transmitters 20 and collect measurement data. When data about the position of the beacon transmitters 20 is collected the mobile device 2 will calculate its position using the measurement data. Thus compared to a traditional mobile device 2, that performs continuous scanning with high power consumption in order to find a wireless communication network for determining its position, the mobile device 2 according to the present invention only performs scanning when it is certain that a wireless communication network is available.

In a second example the mobile device 2 is also configured to be able to receive notifications from an indoor wireless communication network. Thus, as soon as the mobile device 2 is within range of the beacon transmitters 20 of the wireless communication network the mobile device 2 will get notified, since the beacon transmitters 20 perform continuous scanning to identify when a mobile device 2 is within range. When the mobile device 2 has received the notification it will ask the beacon transmitter 20 for its position. Thus, in this second example the beacon transmitters 20 will perform the scanning measurements and will use these measurements to determine the position of the mobile device 2. The beacon transmitters 20 then send the results of this determination back to the mobile device 2. Thus, compared to the first example above further power may be saved since the most power consuming step of performing scanning measurements is done by the beacon transmitters 20 and not by the mobile device 2.

In a third example the mobile device 2 is as in the above examples configured to receive a notification. However this time the notification is sent from the positioning sever 24 instead of the beacon transmitters 20. When the mobile device 2 has received the notification it will ask the positioning server 24 for its position. The positioning server 24 will order the beacon transmitters 20 to perform scanning measurements and collect the result thereof in order to with help of some calculation technique determine the position of the mobile device 2. The positioning server 24 will then send the results of this determination back to the mobile device 2. Thus, compared to the second example above further power may be saved since the mobile device now needs to communicate only with the positioning server 24 and not with the beacon transmitters 20.

It should be understood that the foregoing has described principles, preferred embodiments and modes of operation of present invention. However, the invention should not be limited to particular embodiment discussed above, which should be regarded as illustrative rather then restrictive. Thus, as mentioned above the general inventive concept of the present invention is to let the beacon transmitters 20 of the wireless communication system do the power consuming continues scanning instead of the mobile device 2, i.e. the beacon transmitters 20 are searching for mobile devices 2 instead of the other way around. Thus, the present invention is best defined by the following claims.

1. A method in a mobile device for low power identification of its position in an indoor environment, in which beacon transmitters of a beacon system are present, comprising the steps of
receiving a notification from at least one of the beacon transmitters of the beacon system that notifies the mobile device that it is within the range of the beacon system,
requesting that the beacon transmitters that are within the range of the mobile device send data pertaining to their position, and
determining its position by performing calculations based on such data.

2. The method according to claim 1, wherein the step of receiving the notification further includes the step of
receiving the notification from the beacon transmitter via a positioning server.

3. The method according to claim 1, wherein the calculation is based on range measurements performed by the mobile device.

4. The method according to claim 1, wherein the calculation is based on range measurements performed by the beacon transmitters.

5. The method according to claim 1,
wherein all communication between the mobile device and the beacon transmitters is performed via a positioning server.

6. A mobile device for low power identification of its position in an indoor environment, in which beacon transmitters of a beacon system are present, said mobile device being configured to execute the steps of
receiving a notification from at least one of the beacon transmitters of the beacon system that notifies the mobile device that it is within the range of the beacon system,
requesting the beacon transmitters that are within the range of the mobile device to send data pertaining to their position, and
determining its position by performing calculations based on such data.

7. A mobile device according to claim 6, wherein the mobile device is further configured to execute the step of receiving the notification from the beacon transmitter via a positioning server.

8. A mobile device according to claim 6, wherein the mobile device is configured to perform range measurements on which the calculations are based.

9. A mobile device according to claim 6, wherein the mobile device is configured to receive range measurements from the beacon transmitters on which the calculations are based.

10. A mobile device according to claim 6,
wherein the mobile device is configured to perform all communication with the beacon transmitters via a positioning server.
